(19) United States
(12) Patent Application Publication
(10) Pub. No.: US 2015/0280468 A1
(43) Pub. Date: Oct. 1, 2015

(54) METHOD AND DEVICE FOR TOTAL DISCHARGE PROTECTION OF A STORAGE BATTERY OF A HAND-HELD POWER TOOL

(71) Applicant: HILTI AKTIENGESELLSCHAFT, Schaan (LI)

(72) Inventors: Thomas Müller, Klosterlechfeld (DE); Michael Brandner, Landsberg am Lech/Erpfting (DE)

(21) Appl. No.: 14/434,269

(22) PCT Filed: Oct. 7, 2013
(86) PCT No.: PCT/EP2013/070794

§ 371 Date: Apr. 8, 2015

(30) Foreign Application Priority Data
Oct. 8, 2012 (DE) 10 2012 218 293.4

(51) Int. Cl. H02J 7/00; H02H 7/18; H02H 3/24

(52) U.S. Cl. CPC H02J 7/0029; H02H 3/243; H02H 7/18; H02J 2007/004

(57) ABSTRACT

The present invention relates to a method for total discharge protection of a storage battery of a hand-held power tool, comprising the following steps: determining a current average ON-time of the hand-held power tool; and setting a reference duration for total discharge protection of the storage battery as a function of the determine average ON-time of the hand-held power tool.

### FIELD OF INVENTION

The invention under consideration concerns a method and a device for deep discharge protection of a storage battery of a hand-held power tool.

Current supply of hand-held power tools is increasingly being carried out by storage batteries—for example, lithium ion storage batteries. In order to avoid damage to storage batteries due to deep discharge, a switching-off takes place with known hand-held power tools, when a specific limiting voltage is not reached for a prespecified reference duration.

Although the requirements and charging profile for various hand-held power tools of the storage batteries greatly differ, such storage batteries should be universally used for various hand-held power tools. Moreover, each user has his own usage behavior which is suitable to him. Switching-off after the prespecified reference duration is accordingly not always optimal.

### DISCLOSURE OF THE INVENTION

The method in accordance with the invention for deep discharge protection of a supply battery of a hand-held power tool comprises the following steps: the determination of a current average ON-time of the hand-held power tool and the setting of a reference duration for deep discharge protection of the supply battery, as a function of the determined average ON-time of the hand-held power tool.

In this way, an improved chronologically dynamic and adaptive deep discharge protection is implemented, which is adapted to the user behavior and an actual use of the hand-held power tool, and thus the power behavior of the hand-held power tool is optimized specific to the user and the use. Furthermore, an improved protection of the hand-held power tool is attained, since a deep discharge for a large number of uses of the hand-held power tool is more reliably prevented.

In an embodiment, the method also comprises a switching-off of the hand-held power tool, when a time duration of a falling short of a specific limiting voltage of the supply battery is greater than the set reference duration.

In this way, failed instances of switching-off are reduced. This leads to an increase in the device performance and to an increased range of the hand-held power tool.

In another embodiment of the method, the reference duration is set to a value less than the determined average ON-time of the hand-held power tool.

This makes it possible for the set reference duration to stand in a suitable ratio to the determined average ON-time of the hand-held power tool, so that in addition to an optimized deep discharge protection, a power behavior optimized with regard to the user behavior and the actual use is attained.

In another embodiment of the method, the reference duration is set to a value between 50% and 90% of the determined average ON-time of the hand-held power tool. The range of 50% to 90% of the determined average ON-time is a particularly advantageous value range with regard to an optimized deep discharge protection and a simultaneously optimized power behavior.

In another embodiment of the method, the reference duration can be set to a value less than a maximum permitted reference duration and larger than a minimum permitted reference duration. Thus, it is possible to specify absolute values and a permitted interval within which the reference duration can be set, so that, for example, technical specifications can be taken into consideration with regard to the operating reliability of the hand-held power tool.

In another embodiment of the method, the determined average ON-time of the hand-held power tool is stored as a final determined average ON-time. The storage of the final determined average ON- time makes possible another use for the following averagings. In another embodiment of the method, the average ON-time of the hand-held power tool is determined by an averaging over at least two ON-times of the hand-held power tool. In this way, an arbitrary number of ON-times for the averaging can be taken into consideration, both a few and thus only a short time period of the use of the hand-held power tool, as well as many and thus also a longer usage time period. In another embodiment of the method, the average ON-time of the hand-held power tool is determined by an averaging over at least two ON-times of the hand-held power tool and the finally determined average ON-time. Thus, in addition to the actual ON-times and the actual user behavior, it is possible to also take into consideration the earlier user behavior for the averaging.

In another embodiment of the method, the average ON-time of the hand-held power tool is determined over a set operating time period and/or while taking into consideration a set number of switching-on processes of the hand-held power tool. In this way, it is also possible to also take into consideration the user behavior over one or more defined operating periods, for example, a work day, for an optimized total load discharge. In particular, it is possible to allow one or more finally determined average On-times to be introduced into the actual averaging.

Furthermore, by the consideration of one or more operating periods, it is possible to begin anew the averaging, for example, in each new operating period, with a prespecified starting value within the permitted interval, and to carry out the averaging over the previous number of switching-on processes up to a prespecified number, following the prespecifed number of the last switching-on processes for the actual operating period. Alternatively, it is possible to determine the value of the actual average ON-time in that the finally determined average ON-time is calculated, weighted, with the actual ON-time.

Moreover, the ON-time can be correlated first with a value for a reference duration, whereupon the averaging is then carried out over these correlated values.

In another embodiment of the method, at the time of a first switching-on, the reference duration is set at a starting value less than or equal to the maximum permitted reference duration and greater than or the same as the minimal permitted reference duration. In this way, it is possible to already set a reference duration for deep discharge protection of the supply battery with the first switching-on of the hand-held power tool of the actual operating period or the actual sequence of switching-on processes. This constitutes initialization of the proposed method with a defined value for the reference duration.

Furthermore, a device for deep discharge protection of a battery supply of a hand-held power tool is proposed. The device has a timer for the determination of an actual ON-time of the hand-held power tool and a setting means for the setting of a reference duration for the deep discharge protection of the supply battery as a function of the determined average ON-time of the hand-held power tool.

The individual means, the timer, and the setting means can also be implemented with hardware technology and/or also software technology. With a hardware-technical implementation, the individual means can be designed as a device or as a part of a device, for example, as a computer or as a microprocessor. With a software-technical implementation, the individual means can be designed as a computer program product, as a function, as a routine, as a part of a programmer code, or as an executable object.

Moreover, a hand-held power tool with such a device is proposed. The hand-held power tool is, in particular, an electrical hand-held power tool, such as an electric screwdriver, a hand-held drilling machine, a chisel hammer, a combi-hammer, a cordless screwdriver, a drywall screwdriver, a tangential impact screwdriver, a circular saw, or a reciprocating saw.

### BRIEF DESCRIPTION OF THE FIGURES

The following description explains the invention with the aid of exemplary embodiments and figures. The figures show the following:

FIG. 1, a hand-held power tool; and

FIG. 2, a schematic flow chart of a method for deep discharge protection of a supply battery of a hand-held power tool.

The same or functionally similar elements are indicated with the same reference symbols in the figures, unless otherwise stated.

### EMBODIMENTS OF THE INVENTION

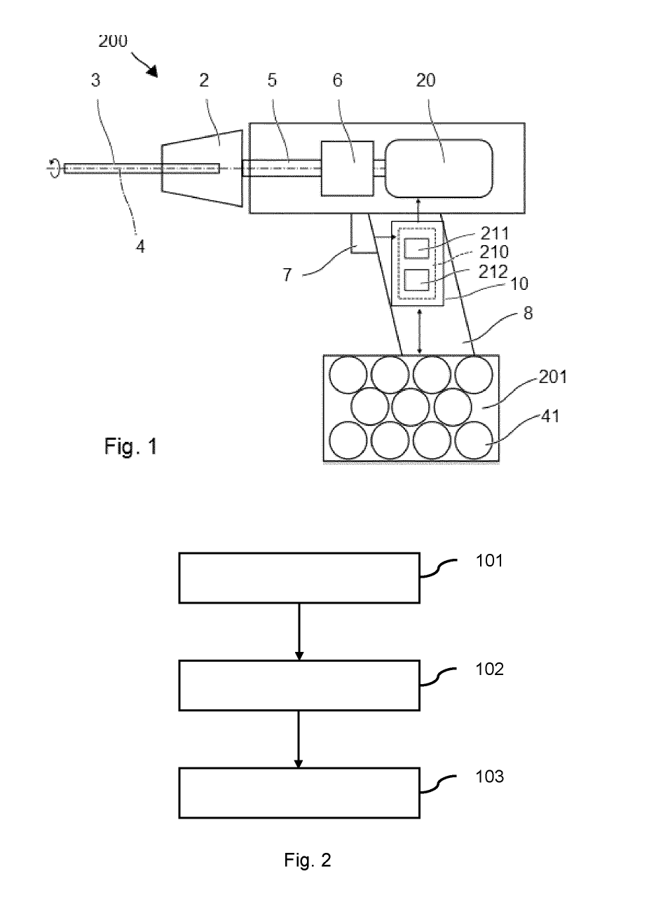

FIG. 1 shows an exemplary hand-held power tool 200, for example, an electric screw driver. The hand-held power tool 200 has a tool holder 2, into which a tool 3 can be inserted or affixed. The tools 3 are, for example, a screwdriver bit, a borer, a grinding disk, and a saw blade. An electric motor 20 drives the tool holder 2, here, for example, rotating around a work axis. A drive train between the tool holder 2 and the electric motor 20 can contain a spindle 5, a gear 6, and other components, for example, a torque coupling, an eccentric wheel.

A user starts the hand-held power tool 200 by activating a button 7. The button 7 is preferably located on a handle 8, with which the user can hold and guide the hand-held power tool 200. A control 10 correspondingly supplies a current to the electric motor 20 upon activation. An exemplary current source of the hand-held power tool 200 is a battery pack 201 (supply battery) with several secondary battery cells 41.

In addition to operating the hand-held power tool 200, the control 10 advantageously monitors the state of the battery pack 201 also. Among other things, the control 10 ends the operation of the hand-held power tool 200 if the charging state of the battery pack 201 falls short of a critical threshold value. The control 10 comprises a monitoring device 210 for deep discharge protection. The monitoring device 210 can, to this end, call up sensor data of the battery pack 201—for example, the actual cell voltage of the individual battery cells 41. If the cell voltage of one or more of the battery cells 41 falls short of a threshold voltage for a reference duration, the deep discharge protection is triggered and the operation of the hand-held power tool 200 is ended.

FIG. 2 shows a schematic flow chart of a method for deep discharge protection of the supply battery 201 of the hand-held power tool 200.

In a first step of the method, a determination 101 of an actual average ON-time of the hand-held power tool 200 is carried out. In another step, a setting 102 of a reference duration for deep discharge protection of the supply battery 201 is carried out as a function of the determined average ON-time of the hand-held power tool 200. In particular, the reference duration is thereby set to a value less than the determined average ON-time of the hand-held power tool 200, which, for example, is in a range between 50% and 90% of the determined average ON-time of the hand-held power tool 200. The range data are thereby based, for example, on a minimal and maximum permitted reference duration, which are produced from technical specifications, for example, for the electric motor 20 of the hand-held power tool 200.

If a time period of a falling short of a specific limiting voltage of the supply battery 201 is greater than the set reference duration, then a switching-off 103 of the hand-held power tool 200 takes place. The limiting voltage can change as a function of the current and the temperature.

The determined average ON-time can be stored and used for another averaging. This is particularly advantageous if, for example, an averaging is to be carried out over switching-on processes during a specific operating period, such as a work day. Simultaneously or alternatively, it is also possible to limit the average to a prespecified number of switching-on processes or to calculate the results of several such averagings with one another—for example, by weighting one or more components of the calculation.

The switching-off 103 prevents another discharge of the supply battery 201 for the protection of the supply battery 201 from damage due to a deep discharge.

FIG. 1 shows a schematic block diagram of the hand-held power tool 200. The hand-held power tool 200 comprises the monitoring device 210 as a part of the hand-held power tool 200. The monitoring device 210 comprises a timer 211 for the determination of the average ON-time of the hand-held power tool 200 and a setting means 212 for the setting of the reference duration for deep discharge protection of the supply battery 201 as a function of the determined average ON-time of the hand-held power tool 200. Alternatively, the monitoring device 210 is integrated into the supply battery 201.

1. A method for deep discharge protection of a supply battery of a hand-held power tool, the method comprising determining an actual average ON-time of the hand-held power tool; and setting a reference duration value for deep discharge protection of the supply battery as a function of the determined average ON-time of the hand-held power tool.

2. The method according to claim 1, comprising switching-off the hand-held power tool if a time period falling short of a specific limiting voltage of the supply battery is greater than the set reference duration value.

3. The method according to claim 1, comprising setting the reference duration value at a value less than the determined average ON-time of the hand-held power tool.

4. The method according to claim 1, comprising setting the reference duration value at a value between 50% and 90% of the determined average ON-time of the hand-held power tool.

5. The method according to claim 1, comprising setting in that the reference duration value at a value less than a maximum permitted reference duration value and greater than a minimal permitted reference duration value.

6. The method according to claim 1, comprising determining the average ON-time of the hand-held power tool by averaging over at least two ON-times of the hand-held power tool.

7. The method according claim 1, comprising storing the determined average ON-time of the hand-held power tool as a finally determined average ON-time.

8. The method according to claim 7, comprising determining the average ON-time of the hand-held power tool by averaging over at least two ON-times of the hand-held power tool and the finally determined average ON-time.

9. The method according to claim 1, comprising determining the average ON-time of the hand-held power tool over a set operating period and/or by considering a set number of switching-on processes of the hand-held power tool.

10. The method according to claim 1, comprising setting the reference duration value at a starting value less than or the same as the maximum permitted reference duration and greater than or the same as the minimal permitted reference duration at the time the hand-held power is first switched on.

11. A monitoring device for deep discharge protection of a supply battery of a hand-held power tool comprising a timer for determining an actual average ON-time of the hand-held power tool; and a setting means for setting a reference duration for deep discharge protection of the supply battery as a function of the determined average ON-time of the hand-held power tool.

12. A hand-held power tool comprising the device for deep discharge protection of the supply battery according to claim 11.
